(19) United States
(12) Patent Application Publication
(10) Pub. No.: US 2002/0091543 A1
(43) Pub. Date: Jul. 11, 2002

(54) Novel method, system, and process for acquiring, evaluating, patenting, and marketing innovation

(76) Inventor: Randhir P.S. Thakur, San Jose, CA (US)

Correspondence Address: Schwegman, Lundberg, Woessner & Kluth, P.A., P.O. Box 2938, Minneapolis, MN, 55402, US

(21) Appl. No.: 10/008,434

(22) Filed: Nov. 13, 2001

Related U.S. Application Data
(60) Provisional application No. 60/249,393, filed on Nov. 15, 2000.

(51) Int. Cl. G06F 17/60

(52) U.S. Cl. 705/1

(57) ABSTRACT

A system is coupled to a network to receive and process inventions submitted by innovators. Descriptions of the inventions are collected, categorized and evaluated. A database containing the evaluated descriptions is made available to potential users or customers of the inventions. The customers can review the inventions by category, or by searching for solutions to problems they would like to solve. Once an invention is identified, the customers can review evaluations including technical feasibility, commercial feasibility and patentability feasibility. A facilitator serves as an arbitrator between innovators and customers for the intellectual property in question. Licenses are also available, and the facilitator may take a percentage of any licenses concluded.

### CROSS-REFERENCE TO RELATED APPLICATIONS

This application is related to and claims the priority of a U.S. Provisional Patent Application entitled “Method, System, and Process for Acquiring, Evaluating, Patenting, and Marketing Innovation,” Serial No.: 60/249,393, filed Nov. 15, 2000, and incorporated herein by reference.

### FIELD OF THE INVENTION

The present invention generally relates generally to managing innovation, and in particular to a method, system, and process for acquiring, evaluating, patenting, and marketing innovative ideas, disclosures, and novel concepts.

### BACKGROUND OF THE INVENTION

Intellectual property in general and patents in particular are increasingly becoming an integral part of global competition for corporate entities and individual innovators. Patents are sometimes one of the more valuable assets of a company.

There are automated tools available in the market for patent analysis such as correlating, analyzing, and otherwise processing patent-related information withnon-patent related information and generating an evaluation worth value result. However, there are no system and process in place for marketeering an individual's idea in a systematic fashion on a global basis.

FIGS. 1A, 1B, and 1C show schematic representations of the prior art methods of obtaining and protecting innovation. FIG. 1A is a simple flowchart that represents corporate entity having multiple employees and associates, and an IP controlling authority that grants rights, such as the U.S. Patent and Trademark Office, Copyright Office, or other right granting authorities in other countries. It should be noted that some intellectual property rights, such as common law and state law protections afforded trademarks and trade secrets may also benefit from the present invention. The resources to obtain protection of inventions, such as filing patent application are provided by the company employees and associates. Once a determination is made to further pursue an innovation and protect it by an issued patent, the assignee (corporate entity) files it with the IP controlling authority. The IP controlling authority makes a determination to issue or reject the invention and the issued patent usually becomes the property of the corporate entity.

FIG. 1B represents another scenario whereby the IP portfolio of corporate entity N is enhanced by the acquisition of different entities. And lastly, in FIG. 1C, inventors pursue the IP on their own and once the inventor attains rights to this IP, the inventors may pursue finding an appropriate company whose interests overlap with the invention, or seek funding from a company or other investor to pursue the invention on their own and use the protected invention to build a new product.

Many individual innovative ideas are not executed due to the expense associated with performing a complete prior art evaluation, technical feasibility, commercial viability and application for a patent. However, the costs of obtaining patent protection can be prohibitive to many sole inventors. While provisional applications allow commercialization for a year to investigate the value of an invention, such commercialization attempts are also quite costly.

There is a need for a system to facilitate such evaluation. There is a need for a system to facilitate exposing ideas to those that can both afford to seek protection and utilize them while at the same time contributing to global technology advancement.

### SUMMARY OF THE INVENTION

Inputs in the form of ideas, concepts, design, method, processes, software, and sub-systems of a system are collected and made available to those that may be interested in commercializing the inputs. Such inputs are referred to as inventions herein. In one embodiment, Internet access as well as conventional communication techniques (written documents, audio and video tapes, and CD ROM, magnetic media and others submitted in person, and by regular and express mail, fax messages) are used to collect inventions and other such intellectual capital in an incubator box such as a database. The inventions are sorted into technical areas or categories and made available to potential users of the inventions, such as corporations around the globe.

Evaluation of the inventions in one embodiment are performed, and the results incorporated into the database. The evaluation may be performed by the corporations, or other users of the system. In one embodiment, the owner of the incubator box provides a group of qualified evaluators. Evaluations include prior art searching and patentability opinions (legal evaluations), technical feasibility, and commercial viability.

A facilitator keeps inputs accessible, competitive, flexible, neutral and global by coordinating inputs from innovators, evaluators and potential users of the inventions. A decision is generated regarding seeking patent protection, refining the invention, or declining it. As a business plan, funding for a patent application or other protection may be provided by the potential users, and licensing arrangements may be entered into the system. By using the latest web based technologies, an expedited use of communication and collaboration means is possible. The invention facilitates a heterogeneous system that is essentially networked worldwide.

The system reduces the cycle time from concept to market by facilitating information flow between innovators and potential users. In terms of the business plan, it also provides control of disclosure to potential users by allowing innovators the option to exclude certain users at their choice. The system provides for potential fees for viewing data, and allows bidding for access to data, with the highest bidder obtaining the right to the data for their use. The system also provides for anonymity of the innovator and potential user if desired. In essence, the facilitator serves as an arbitrator between the two for the intellectual property in question. Licenses are also available, and the facilitator may take a percentage of any licenses concluded. Such a business process provides a needed velocity to an invention or solution to a problem to reach commercial use faster.

Another embodiment of the invention involves the ability to leverage intellectual capital globally and help put in place standards of evaluating and securing inventions, even in places that lack infrastructure, and in countries that have no such system in place, but do have intellectual wealth that needs to be properly managed. Essentially, the invention helps define the standards where needed, provides a knowledge management tool where desired and efficiently helps people in such places to protect and leverage their creations no matter which part of the globe they chose to live.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures, in which:

FIGS. 1A, 1B, and 1C show prior art methods of obtaining rights for inventions;

FIG. 2 is a block diagram showing a system for facilitating protection and communication of inventions between innovators and potential users;

FIG. 3 is a flowchart depicting the general operation of the system of FIG. 2;

FIG. 4 is a block diagram showing further detail of the system of FIG. 2;

FIG. 5 is a block diagram that shows the main hardware systems and operation of the present invention;

FIG. 6 is a flowchart that illustrates one embodiment of the present invention;

FIG. 7 is a flowchart that illustrates yet another embodiment of the present invention; and

FIG. 8 is a flowchart that illustrates a further embodiment of the present invention.

FIG. 9 is a flowchart that illustrates a further embodiment of the present invention that combines multiple ideas for evaluation.

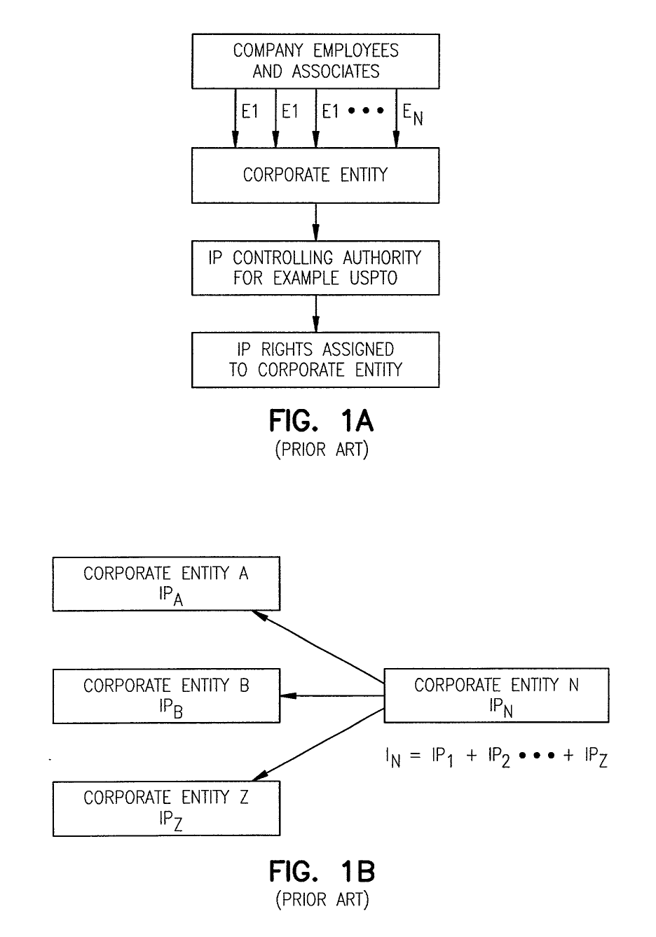

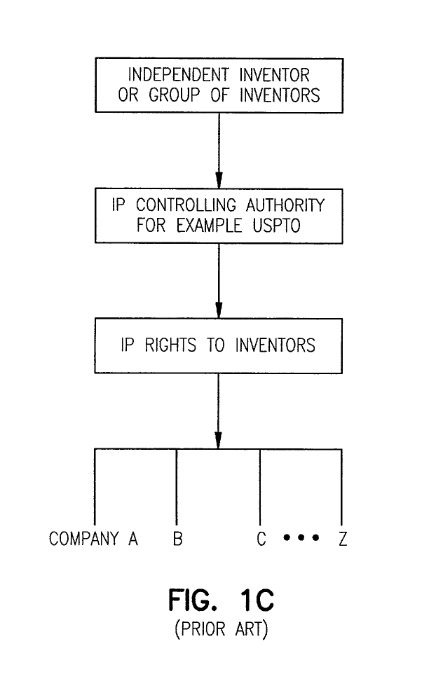

Repeat use of reference characters in the present specifications and drawings is intended to represent same or analogous features or elements of the invention.

### DETAILED DESCRIPTION OF PREFERRED EMBODIMENTS

It is to be understood by one of ordinary skill in the art that the present discussion is a description of exemplary embodiments only, and is not intended as limiting the broader aspects of the present invention.

In general, the present invention consists of an intellectual property server and electronic system implemented for submitting innovative ideas, and a computer-implemented system database for collecting, classifying, storing and valuing an intellectual property portfolio. Software for the system is stored on computer readable medium. In one embodiment the software is stored on secondary storage, such as a disk drive and loaded into main memory and cache of the computer as needed. The software is written in the form of modules that generally provide a single function or subsets of related functions. However, in various embodiments, the software comprises a single module or many modules, and there is no requirement that functions be grouped together. Hardware and/or firmware is used to implement the invention in further embodiments. The software may implement the functions, or simply facilitate the performance of the function by a human by providing menu driven interfaces, information from databases, and providing information to the system for database storage.

In one embodiment of the present invention, the context of the Internet or other distributed network space is utilized. By utilizing the Internet or some other network, the concepts and the business plan proposed in this invention provides massive capability to do searches in any information space filled with technologies, cultures, prior art, and also puts the inventions in context.

Globalization has been an incredible possibility due to the Internet. Utilizing the invention can leverage the diversity of globalization further. Knowledge management and innovation so far has stayed around the organizations, companies, national laboratories, and within government jurisdictions depending on the need. This concept precipitated intellectual wealth and in the case of companies, their ability to compete and deliver proprietary products enhanced significantly. It has been, therefore, a common practice to associate the new ideas and patents as the integral part of the organizations.

The current invention deals with the business of inventions. It is designed to give a leverage to the common, creative, and capable people around the globe an opportunity to document their ideas, put in writing the ideas of their experiences and experiments if those are new and unique, and using the provided capability as described here, to eventually “secure” the rights to such ideas.

There are countries today who cannot really afford to build an infrastructure for protecting innovation that is on par with the United States. That simply does not mean that people living in such countries are not able to generate new ideas or pursue inventions, copyrights, and trade secrets, but that a system does not exist. The current model essentially eliminates such a drawback.

In this invention an internet-based capability is proposed. The implication of such a capability is that people anywhere around the globe can submit their ideas (based on the guidelines as explained in this invention herein) and explore possibility of protection.

Internet access is used to collect people's innovative ideas. An evaluation system evaluates each idea against prior art, granted patents, implementation feasibility and market opportunities and generates a decision on applying for a patent, refining the idea or declining it. A search is conducted for identifying potential companies that may be interested in buying the rights of use for applied patents. Once rights of use are sold, the idea provider is benefited in a form of payment for the patent life of use.

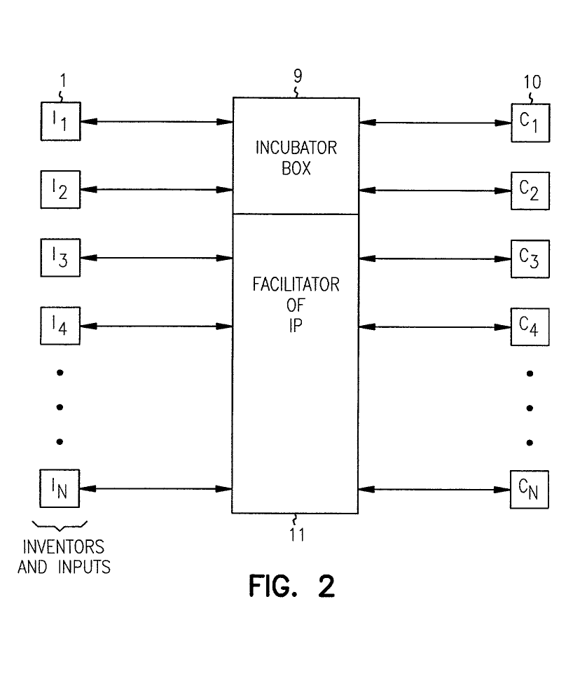

In FIG. 2, inputs 1 are represented herein as I₁, I₂, I₃, I₄. . . . . . . . . I_{N} are fed into a facilitator 11 and incubator box 9. The facilitator of innovation 11 and incubator box 9 are not dependent on the technology used in the implementation of hardware and software. The state of the art technology involves the wired connections between incubator box 9 and facilitator 11. However, wireless technology such as microwave based or infrared photons, or even potential disruptive technologies such as optical computing, quantum computing, spin based computation, DNA based computation or even biological computing is contemplated in further embodiments.

Customers 10, represented as C₁, C₂, C₃, C₄. . . . C_{N} also have access to the incubator 9 and facilitator 11. Access for each inventor's invention is accessible to a large customer base due to the facilitator and associated incubator box.

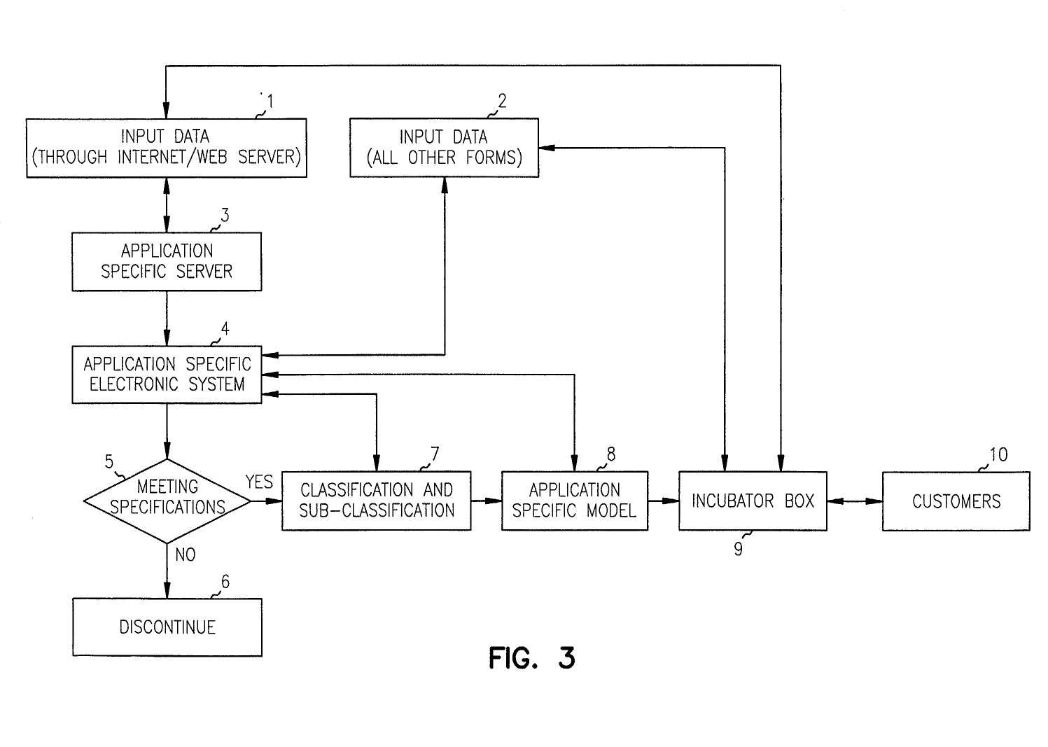

FIG. 3 shows input data ports 1, 2 that are interactive to guide an innovator through providing sufficient information to clearly identify their invention. Input 1 provides for descriptions of inventions and supporting information via a network connection, and enables the use of electronic files, such as documents and images. Input 2 provides the ability to fax and mail hardcopy materials. Hardcopy materials my be processed using character recognition, and may also be categorized by humans. Both inputs allow an innovator to provide new ideas, concepts, design to the application specific server 3 and application specific electronic system 4 wherein the inputs can be in electronic and non electronic form. Inputs are evaluated according to the facilitator as shown in 5. The facilitator first determines if the inputs are properly formatted and properly describe the invention. The facilitator can be at least partially automated via software for such functions as ensuring that background data, such as name, address and phone number are supplied, as well as other predetermined sets of conditions including feasibility and other milestones. The results may be stored in separate fields of the database, and may also comprise text and image files having pointers from the database. Payment information may also be verified electronically. Such software can also perform other automated analysis, such as keyword identification and lexical analysis.

If the inputs do not meet the specifications or predetermined set of conditions, they are discarded according to 6 and if specifications are met, these inputs go into the classification and sub-classification module 7. The keywords may be used at this point to properly classify the invention. Application specific model 8 further processes the inputs and these become part of the incubator box 9, which are then accessible both by the customers 10 as well as the input providers 1 and 2. The facilitator 11 has the ownership of the incubator box and all transactions related to the inputs and customer base.

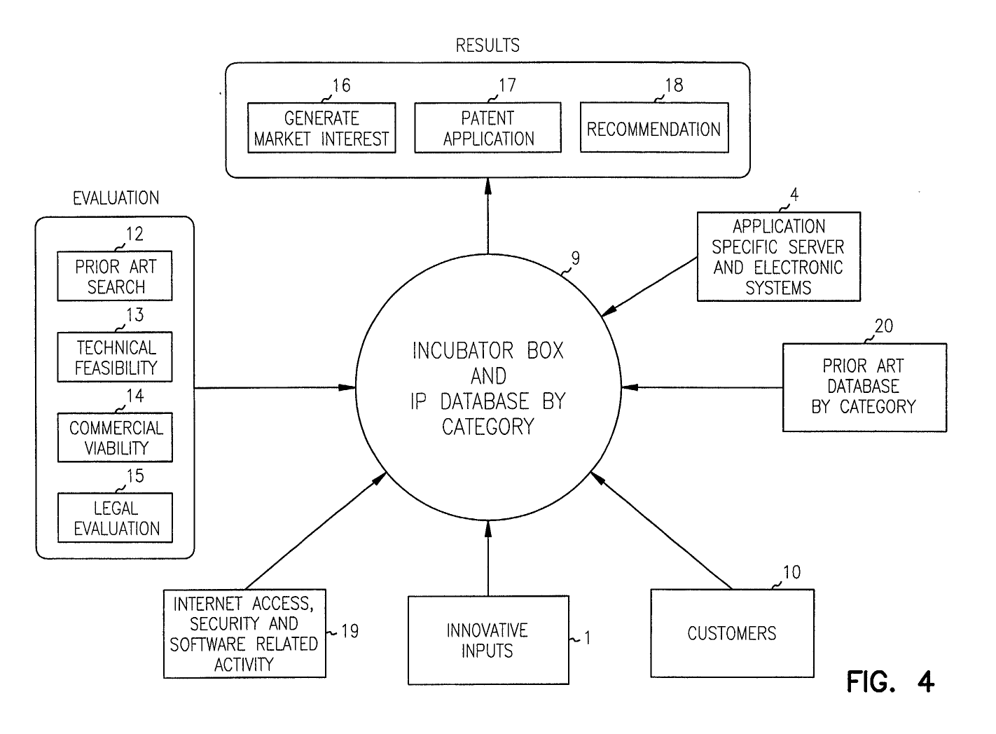

FIG. 4 is a block diagram that illustrates the main sections of the system. The incubator box 9 which has the IP database by category generated from the inputs 1 and 2 is essentially central to the entire invention and it's various embodiments. The IP database reflects the evaluation, results, application specific server and electronic systems, prior art database by category 20, customers 10 and the like. The general evaluation block contains important hardware, software, and human activity blocks as only general examples, which can be partitioned further in more details. Prior art search 12, technical feasibility 13 for the inputs received, commercial viability option 14 and legal evaluation 15 are shown as part of the evaluation block. They represent human or automated activities that may be performed serially or in parallel. All of these blocks are key elements to the decision matrix and impact the inputs individually and collectively. The evaluations may be form based with the results scored, or may simply be free text setting forth the opinion of the author. In one embodiment, the commercial viability evaluation is based on potential licensing value, including such factors as solving a problem faced by many people, lack of feasible alternatives and other factors such as simplicity and widespread applicability.

Results include the generation of market interest 16, a patent application or other form of protection 17, and a recommendation 18. This information is added to the database for further consideration by innovators and potential users. Internet access, security and software related activity 19 is another feature of the present invention that ensures confidentiality and protects the business plan against hackers and releasing information to unauthorized sources. Security 19 is central to any new software and algorithm improvements.

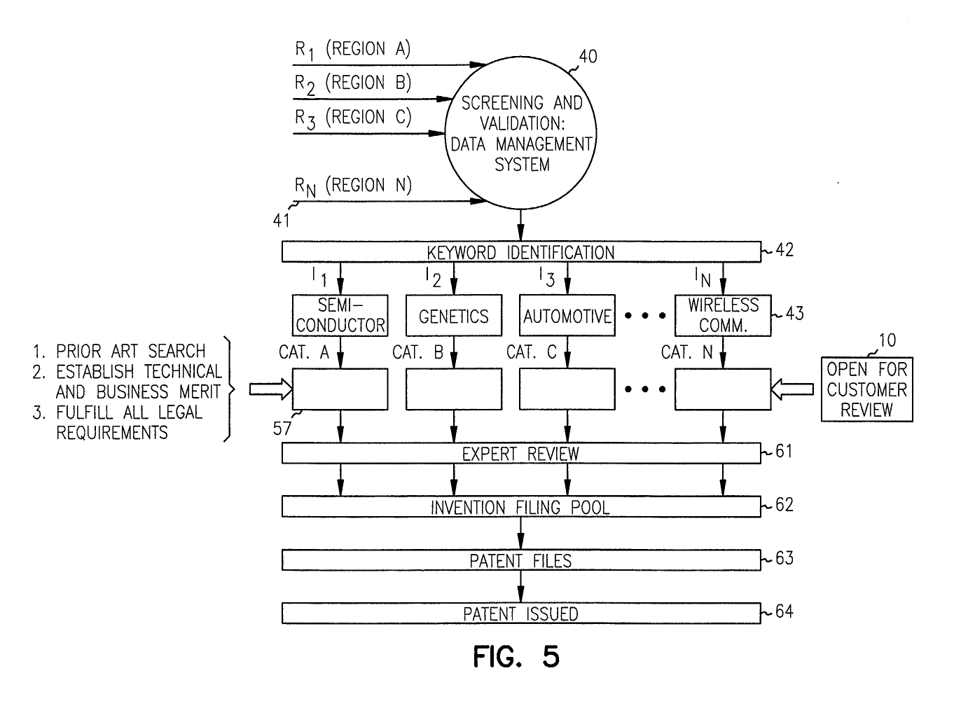

FIG. 5 illustrates one embodiment of the flow of inputs through various blocks of the invention. Inputs across the globe are categorized in regions 41 and are brought into the data management system 40 for screening and validation as previously discussed. Keyword identification 42 directs the inputs received to different categories 43, which may be predetermined, such as International classification systems. All inputs are represented at 57 where technical and business merit, legal evaluation and prior art search are all used to evaluate the input. In addition, the inputs are exposed to potential user or customer review 10. After expert review 61, the inputs are transferred to an invention filing pool 62. Subsequently patents 63 are filed depending on the business need and customer interest, feedback and potential funding of the applications. The inputs forwarded to the IP controlling authority become the issued patents 64 and integral part of the incubator box as proposed in this invention.

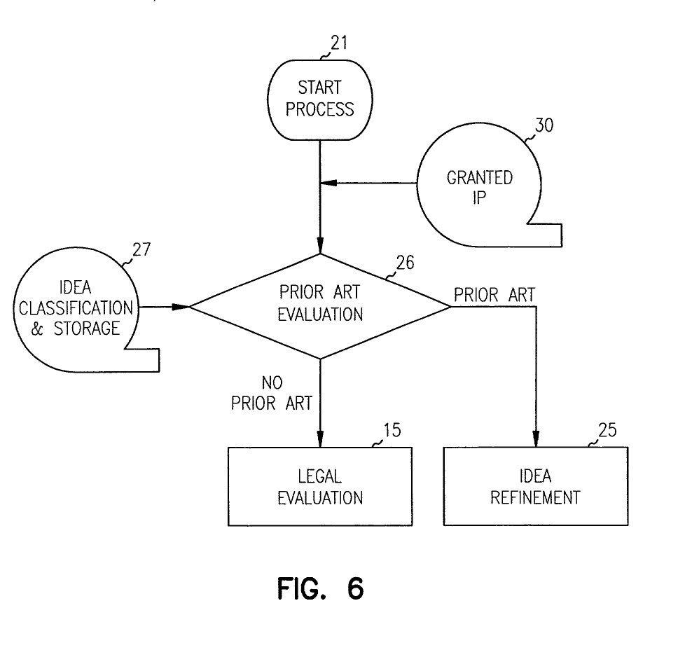

FIG. 6 shows a flow chart for one of the various decision matrices used in this invention. A process to evaluate an input from idea classification and storage 27 is initiated at 21 and evaluated against granted intellectual property, IP30 and other prior art. Prior art evaluation 26 determines whether a given input needs refinement 25 or can be sent further for legal evaluation 15.

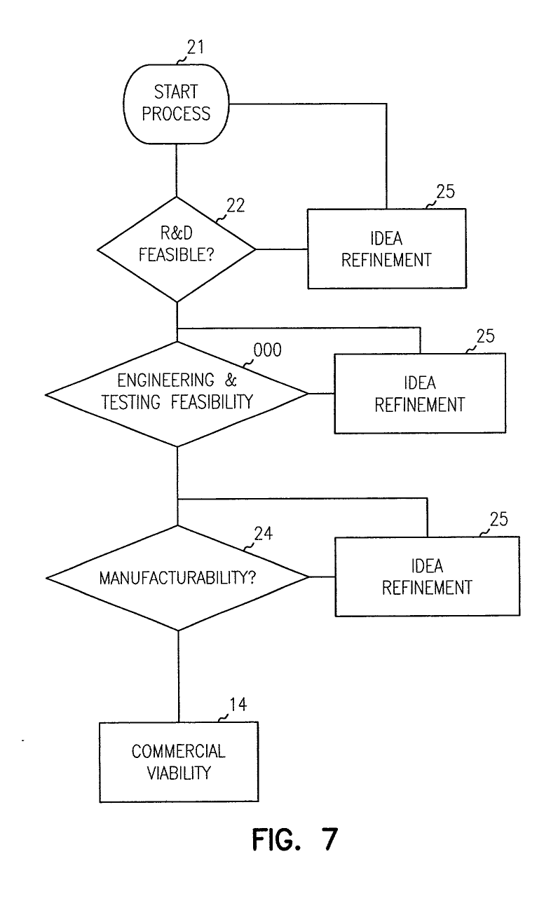

Further detail of evaluation is shown in the flowchart of FIG. 7. The process starts at 21, and evaluation is expanded to new stages of R&D feasibility 22, engineering and testing feasibility 23, manufacturability 24 and commercial viability 14 to ensure that the decision criteria as described earlier are met according to the present invention. At any stage of evaluation or collectively through the stages shown herein, if there are deficiencies, the input is transferred to idea refinement 25 and the overall process is repeated all over again or in part.

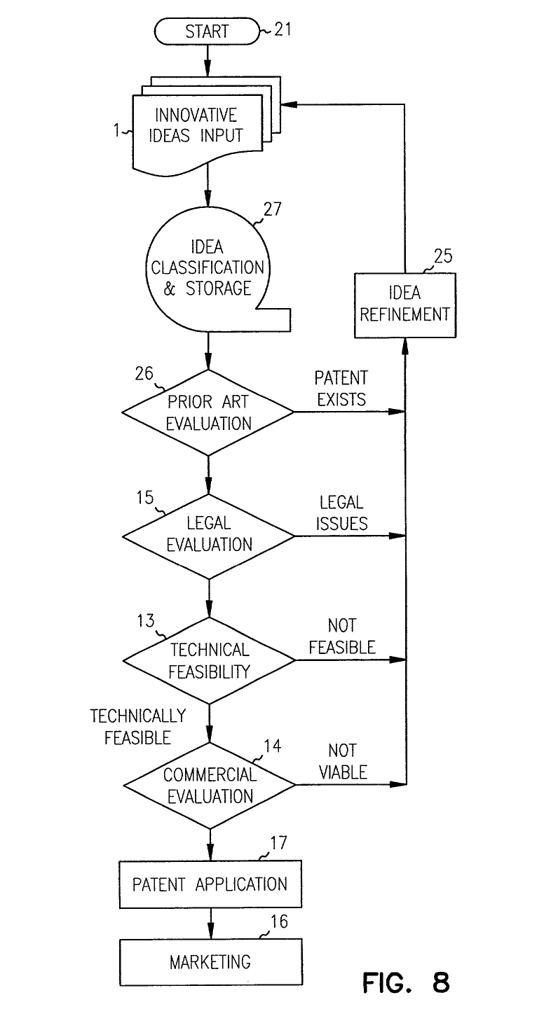

FIG. 8 further expands this logic to include some additional embodiments of the present invention used towards evaluation of the inputs. The blocks labeled prior art evaluation 26, legal evaluation 15, technical feasibility 13, commercial evaluation 14, patent application 17, marketing 16, and idea refinement 25 show one sequence that explains the evaluation and decision making process used. Further input and evaluation may also be provided, including the facilitation of licensing inventions by providing licensing agreements and mediation services. The licensing agreements may provide for any type of royalty desired, and include funding for pursuit of the patent application. Further allowances are made for assigning inventions to users for pursuit of protection and marketing.

The facilitator may obtain an agreement with both potential users and innovators for various service fees that occur with different milestones. A first fee may be charged for submission of an invention, which may or may not include evaluation. Different evaluations may entail different fees, or a single fee may be charged for all evaluations. A further commission is provided for if the invention is licensed or sold. The potential users in one embodiment pay an up front fee for access to the pool of inventions, and in another embodiment, agree to pay a commission upon finding an invention they wish to pursue. This commission could be based on the total value of the deal, or a fixed fee per invention pursued.

Definitions of some of the terms used in the present invention are provided here.

Innovative Ideas/Inventions

Internet site where people can submit their innovative ideas in a specific format; this includes specific instructions for filling fields with necessary information. Fields include name, address, phone number, abstract, field of invention, industry etc. . . The site handles interface with the user, Internet site, communicates with the personal computer, PC or other computing devices based on electronic and photonic interfaces and controls. The additional capabilities of such a system include instant language translations, voice and image processing and other wireless features designed for high speed.

Classification to Field of Invention

Innovative ideas are classified and filed based on their field of application such as automotive, semi-conductor, aerospace, communication, internet, biological, and biomedical engineering, etc...

IP Database

An up to date database of granted patents and foreign applications and granted patents based on fast computing capabilities. The database contains the intellectual property such as patents, trademarks, and literature.

Prior Art Search

A search function for prior art; it uses the IP database, on-line databases from commercial vendors covering arrays of business and technical articles and information, and the innovative ideas as inputs to check if the idea is already in the public domain or already patented. An interactive search system is installed.

Technical Feasibility

A function for evaluating the feasibility of ideas in terms of R&D, engineering, testing, manufacturability and product feasibility.

Commercial Viability

A set of commercial parameters such as productization, cost, market and other such benefits based on the idea is evaluated against.

Legal Evaluation

Evaluating any legality issues related to the inventor, the prior art search results and the interested third party. The business model accounts for all legal processes.

Recommendation

Evaluation results recommending whether to proceed with a patent application refine the idea/invention and re-evaluate or drop the idea.

Patent Application

Once decision is made to proceed, then patent application is filed in US and foreign patent offices.

Generate Market Interest

Inventions may also be marketed to potential companies that may have interest and may benefit from them.

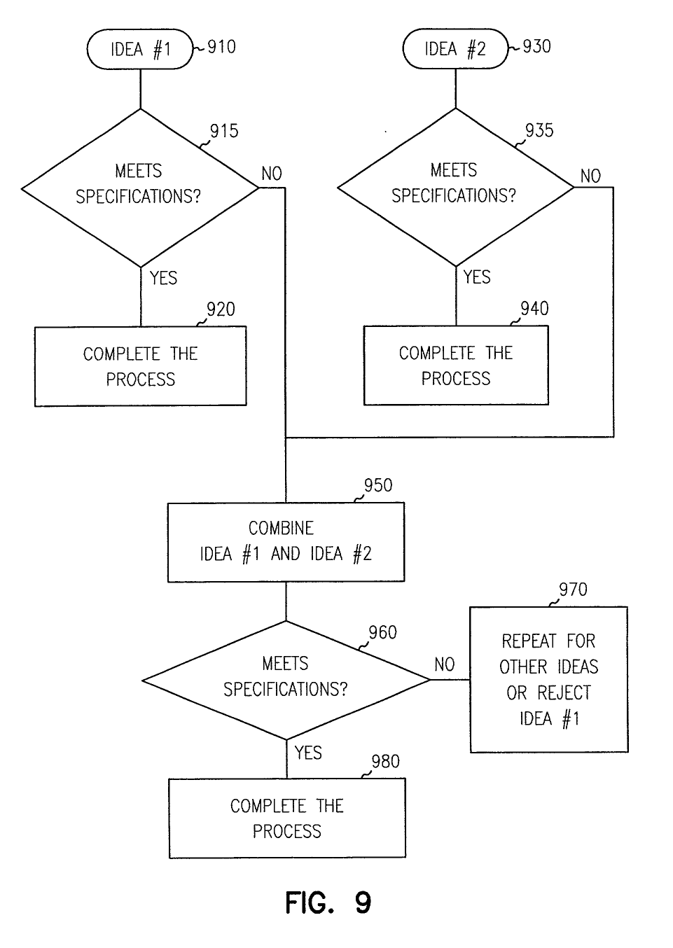

Ideas are combined in FIG. 9 in order to determine if the combination of two ideas provides a combined idea which can be more favorably evaluated. A first idea, idea #1 is received at 910 and evaluated at 915 similarly to the evaluations described in FIG. 8. If it is found to meet specifications at 915, the process of protecting and marketing idea #1 is performed at 920. Meeting specifications is a short hand notation for a successful evaluation.

Idea #2 is received at 930 and similarly evaluated at 935, and protected and/or marketed at 940. If neither idea meets specifications at 915 and 935, they are combined at 950. The combination is performed by the facilitator in one embodiment wherein the facilitator is a person experienced at processing and evaluating inventions. Once combined, the combined idea is evaluated at 960, and if it meets specifications, the protection, exploitation process is completed at 980. If the combined idea does not meet specifications at 960, it is combined with other ideas at 970 and further evaluated. The combination with different ideas is decided and performed by the facilitator in one embodiment, and is repeated for as many different combinations as is feasible. More than two ideas are combined in further embodiments. The combination may also be based on perceived symbiotic benefits.

A system is coupled to a network to receive and process inventions submitted by inventors. Descriptions of the inventions are collected, categorized and evaluated. A database containing the evaluated descriptions is made available to potential users or customers of the inventions. The customers can review the inventions by category, or by searching for solutions to problems they would like to solve. Once an invention is identified, the customers can review evaluations that might include technical feasibility, commercial feasibility and patentability feasibility.

A facilitator keeps inputs accessible, competitive, flexible, neutral and global by coordinating inputs from innovators, evaluators and potential users of the inventions. A decision is generated regarding seeking patent protection, refining the invention, or declining it. Funding for a patent application or other protection may be provided by the potential users, and licensing arrangements may be entered into via the system.

Such a flexible business model uniquely helps knowledge management and helps globally standardize intellectual capital so that it is the idea that is competed upon, not the background of the inventor and other such factors.

Primary components of initiating a process in accordance with the model include specific ways of setting up the database, a method to invite participation in an internet or other such interactive communication environment, and maintaining an overall value chain to complete such an activity. The present invention covers sequences of steps that provide a specific link of an activity and have a feedback loop with a set of protocols to make it interactive. It captures the inputs and inventions from users, streamlines these in databases that are networked globally, allocates specific decisions to each input, modifies the input values to a new set of functional conditions and takes other needed actions to refine the qualitative value of inputs without altering the fundamental specification of the input, shares output with the input, provides and repeats this process.

The system reduces the cycle time from concept to market by facilitating information flow between innovators and potential users. It also provides control of disclosure to potential users by allowing innovators the option to exclude certain users at their choice. The system provides for potential fees for viewing data, and allows bidding for access to data, with the highest bidder obtaining the right to the data for their use. The system also provides for anonymity of the innovator and potential user if desired. In essence, the facilitator serves as an arbitrator between the two for the intellectual property in question. Licenses are also available, and the facilitator may take a percentage of any licenses concluded.

What is claimed is:

1. A system for facilitating use of inventions in accordance with a business model, the system comprising:
a server coupled to a network for receiving descriptions of inventions;
a classification module for classifying inventions into predetermined classes;
an evaluation module for providing evaluations of the inventions; and
a database for storing the descriptions of inventions and evaluations by class and providing search facilities via the network for potential customers not related to the innovators to find inventions.

2. The system of claim 1 wherein the evaluations are selected from the group consisting of prior art searches, technical feasibility reviews, commercial viability analysis and legal evaluation.

3. The system of claim 1 wherein the server further comprises a facilitator for controlling interaction between innovators and potential customers.

4. The system of claim 3 wherein the facilitator provides for potential customers to fund intellectual property protection for inventions.

5. The system of claim 3 wherein the facilitator provides the ability to refine inventions based on evaluations.

6. The system of claim 3 wherein the facilitator controls access to a selected group of potential customers.

7. The system of claim 1 wherein an owner of the system is provided rights to a royalty on the inventions.

8. The system of claim 1 and further comprising a translation module that translates descriptions of inventions.

9. The system of claim 1 wherein the database also contains indications of issued patents on inventions.

10. The system of claim 1 wherein the server further screens and validates descriptions of inventions.

11. A computer implemented business model of facilitating the use and protection of inventions, the model comprising:
receiving descriptions of inventions;
categorizing the inventions;
evaluating the inventions for potential licensing value;
providing a database containing the inventions and evaluations; and
making the database selectively viewable to potential customers of the inventions who are not related to the innovators.

12. The method of claim 11 wherein evaluating is performed with respect to prior art searches, technical feasibility reviews, commercial viability analysis and legal evaluation.

13. The method of claim 12 wherein and further comprising controlling interaction between innovators and potential customers.

14. The method of claim 12 wherein controlling interaction between innovators and potential customers comprises providing anonymity of at least one of the innovators and potential customers.

15. The method of claim 12 and further comprising providing for potential customers to fund intellectual property protection for inventions.

16. The method of claim 12 and further comprising providing the ability to refine inventions based on evaluations.

17. The method of claim 11 and also comprising providing indications of issued patents on inventions.

18. The method of claim 11 and further comprising screening and validating descriptions of inventions.

19. The method of claim 11 and further comprising controlling access to a selected group of potential customers.

20. The method of claim 11 and further comprising providing rights to a royalty on the inventions.

21. The method of claim 11 and further comprising translating descriptions of inventions to desired languages.

22. A method of facilitating invention in accordance with a business model, the method comprising:
receiving invention input from multiple independent innovators coupled by network;
validating the invention input;
categorizing the invention input into discrete technical categories;
evaluating the invention input;
providing a recommendation based on the evaluations; and
making the invention input and recommendation available to selective independent customers via network connection.

23. The method of claim 22 wherein evaluating is based on at least one of prior art searching, technical feasibility, commercial viability and legal evaluation.

24. The method of claim 22 and further comprising facilitating protection of an invention by involving a potential customer to provide funding for such protection in exchange an interest in the invention.

25. The method of claim 24 wherein at least some of the elements are performed by humans.

26. The method of claim 22 and further comprising controlling access to a selected group of potential customers.

27. The method of claim 22 and further comprising providing rights to a royalty on the inventions.

28. The method of claim 22 and further comprising translating descriptions of inventions to desired languages.

29. A system for facilitating invention in accordance with a business model, the system comprising:
a module that receives invention input from multiple independent innovators coupled by network;
a module that validates the invention input;
a module that categorizes the invention input into discrete technical categories;
a module that evaluates the invention input;
a module that provides a recommendation based on the evaluations; and
a module that makes the invention input and recommendation available to selective independent customers via network connection.

30. The system of claim 29 wherein the modules are managed by an entity that owns the business model.

31. A computer readable medium having instructions thereon for causing a server computer to execute a method of facilitating invention, the method comprising:
receiving invention input from multiple independent innovators coupled by network;
facilitating validation of the invention input;
facilitating categorization of the invention input into discrete technical categories;
facilitating evaluation of the invention input;
facilitating the provision of a recommendation based on the evaluations; and
facilitating the making of the invention input and recommendation available to selective independent customers via network connection.
